(19) United States
(12) Patent Application Publication
(10) Pub. No.: US 2025/0245493 A1
(43) Pub. Date: Jul. 31, 2025

(54) STYLING A DIGITAL SPACE USING MULTI-MODAL IMAGE GENERATIVE ARTIFICIAL INTELLIGENCE

(71) Applicant: Walmart Apollo, LLC, Bentonville, AR (US)

(72) Inventors: Rushikesh Dudhat, San Jose, CA (US); Nima Eshraghi, Toronto (CA); Himani Saini, Mississauga (CA); Vadivel Palaniappan, Mississauga (CA); Deepa Mohan, Los Altos, CA (US)

(73) Assignee: Walmart Apollo, LLC, Bentonville, AR (US)

(21) Appl. No.: 19/042,368

(22) Filed: Jan. 31, 2025

Related U.S. Application Data
(60) Provisional application No. 63/627,696, filed on Jan. 31, 2024.

(51) Int. Cl. G06N 3/0475; G06N 3/096

(52) U.S. Cl. CPC G06N 3/0475; G06N 3/096

(57) ABSTRACT

A system including a processor and a non-transitory computer-readable media storing computing instructions that, when executed on the processor, cause the processor to perform certain operations: obtaining an image of a digital space; extracting a depth map and a segmentation map of the image; passing each of the depth map and the segmentation map through a respective model of two parallel image diffusion models using stable diffusion with controlled image generation; prompting a selection of a target style for the digital space; segmenting, using image segmentation, the image in a target stylized digital space; and determining, using dominant color filtering, visual images of complementary items. Other embodiments are described.

### CROSS-REFERENCE TO RELATED APPLICATION

This application claims the benefit of U.S. Provisional Application No. 63/627,696, filed Jan. 31, 2024, which is incorporated herein by reference in its entirety.

### TECHNICAL FIELD

This disclosure relates generally to styling a space using multi-modal generative artificial intelligence.

### BACKGROUND

Interior design can be challenging for customers. When viewing home décor items, customers often do not have a sense of how the items would look in their homes. Style mismatches often do not become apparent until the item is purchased and placed in the room.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system of styling a digital space using multi-modal generative artificial intelligence, according to an embodiment;

FIG. 4 illustrates a flow chart for a method of styling a digital space using the multi-modal generative artificial intelligence, according to an embodiment;

FIG. 5 illustrates a flow chart for a method of styling a digital space using multi-modal generative artificial intelligence;

FIG. 6 illustrates examples of conditional mapping by extracting pixels from an image to create a segmentation map by using a segmentation algorithm;

FIG. 7 illustrates a block diagram for a method of using a multi-modal scene generation model to style a digital space into a target style digital image, according to an embodiment;

FIG. 8 illustrates a flow chart of a method of fine tuning stable diffusion by transforming image captions that are insufficiently descriptive of the text-to-image generative AI process to create digital spaces or scenes match the textual description;

FIG. 9 illustrates a flow diagram for a method of segmenting an image of a generated digital image of a stylized room scene to identify objects of interest in the image;

FIG. 10 illustrates a flow diagram for a method of dominant color filtering to create visual embeddings of a color profile matching a complementary dominant color of an item in the style of the target style, according to an embodiment; and

FIG. 11 illustrates a flow diagram for a method of dominant color filtering using color histograms, according to an embodiment.

### DETAILED DESCRIPTION

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

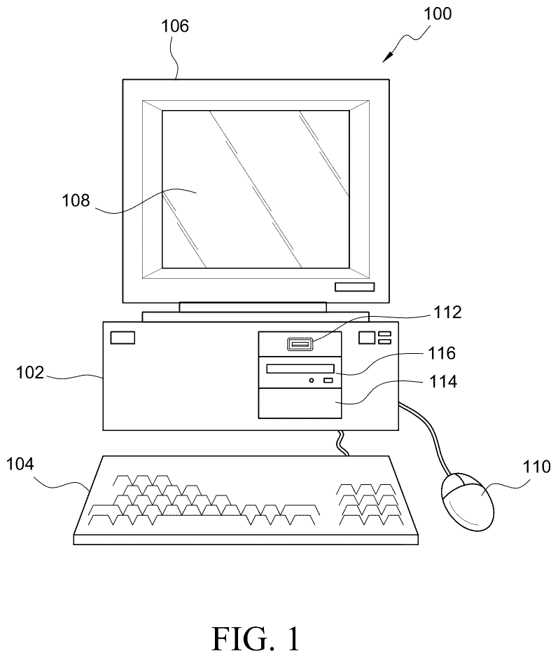

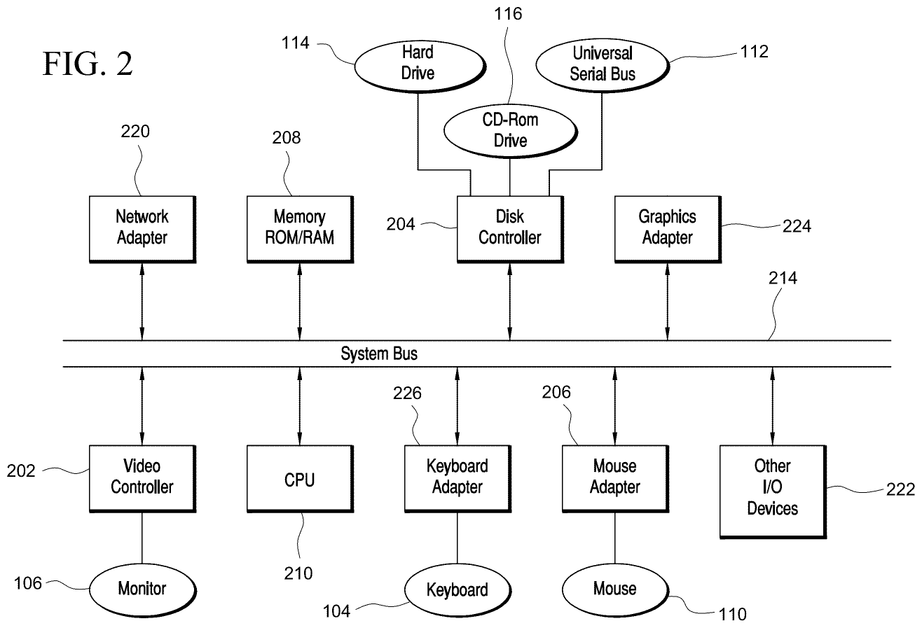

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative activity diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

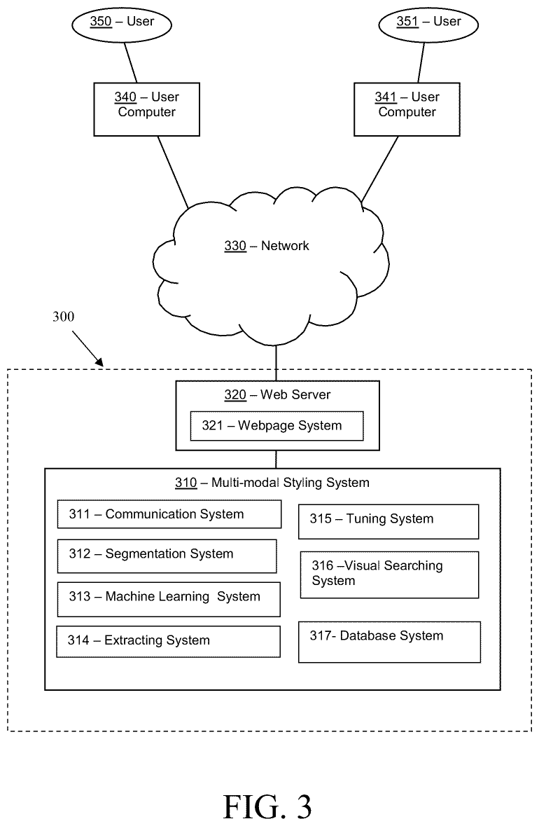

Turning ahead in the drawings, FIG. 3 illustrates a block diagram of a system 300 of styling a digital space using multi-modal generative artificial intelligence, according to an embodiment. System 300 is merely exemplary, and embodiments of the system are not limited to the embodiments presented herein. The system can be used in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include a multi-modal styling system 310 and/or a web server 320. Multi-modal styling system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host two or more of, or all of, multi-modal styling system 310 and/or web server 320. Additional details regarding multi-modal styling system 310 and/or web server 320 are described herein.

In a number of embodiments, each system of multi-modal styling system 310 and/or web server 320 can be a special-purpose computer programed specifically to perform specific functions not associated with a general-purpose computer, as described in greater detail below.

In some embodiments, web server 320 can be in data communication through a network 330 with one or more user computers, such as user computers 340 and/or 341. Network 330 can be a public network, a private network, or a hybrid network. In some embodiments, user computers 340-341 can be used by users, such as users 350 and 351, which also can be referred to as customers, in which case, user computers 340 and 341 can be referred to as customer computers. In many embodiments, web server 320 can host one or more sites (e.g., websites) that allow users to browse and/or search for items (e.g., products), to add items to an electronic shopping cart, and/or to order (e.g., purchase) items, in addition to other suitable activities. In many embodiments, web server 320 can host one or more sites (e.g., websites) that allow users to interface with multi-modal styling system 310, such as to generate multiple pickup/delivery day options to enable a user to style a digital space using multi-modal generative artificial intelligence, in addition to other suitable activities.

In some embodiments, an internal network that is not open to the public can be used for communications between multi-modal styling system 310 and/or web server 320 within system 300. Accordingly, in some embodiments, multi-modal styling system 310 (and/or the software used by such systems) can refer to a back end of system 300, which can be operated by an operator and/or administrator of system 300, and web server 320 (and/or the software used by such system) can refer to a front end of system 300, and can be accessed and/or used by one or more users, such as users 350-351, using user computers 340-341, respectively. In these or other embodiments, the operator and/or administrator of system 300 can manage system 300, the processor(s) of system 300, and/or the memory storage unit(s) of system 300 using the input device(s) and/or display device(s) of system 300.

In certain embodiments, user computers 340-341 can be desktop computers, laptop computers, a mobile device, and/or other endpoint devices used by one or more users 350 and 351, respectively. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Palm® operating system by Palm, Inc. of Sunnyvale, California, United States, (iv) the Android™ operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can include a mobile device, and vice versa. However, a wearable user computer device does not necessarily include a mobile device, and vice versa.

In specific examples, a wearable user computer device can include a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can include (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can include the Virtual Retinal Display™ product, or similar product by the University of Washington of Seattle, Washington, United States of America. Meanwhile, in further specific examples, a limb mountable wearable user computer device can include the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

In several embodiments, system 300 can include one or more input devices (e.g., one or more keyboards, one or more keypads, one or more pointing devices such as a computer mouse or computer mice, one or more touchscreen displays, a microphone, etc.), and/or can each include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 300. In a similar manner, the processors and/or the non-transitory computer-readable media can be local and/or remote to each other.

Meanwhile, in many embodiments, system 300 also can be configured to communicate with and/or include one or more databases, such as database system 317. The one or more databases can include a product database that contains information about products, items, or SKUs (stock keeping units), for example, among other data as described herein, such as described herein in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between system 300, network 330, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, multi-modal styling system 310 can include a communication system 311, a segmentation system 312, a machine learning system 313, an extracting system 314, a tuning system 315, a visual searching system 316, and/or database system 317. In many embodiments, the systems of multi-modal styling system 310 can be modules of computing instructions (e.g., software modules) stored at non-transitory computer readable media that operate on one or more processors. In other embodiments, the systems of multi-modal styling system 310 can be implemented in hardware. Multi-modal styling system 310 can be a computer system, such as computer system 100 (FIG. 1), as described above, and can be a single computer, a single server, or a cluster or collection of computers or servers, or a cloud of computers or servers. In another embodiment, a single computer system can host multi-modal styling system 310. Additional details regarding multi-modal styling system 310 and the components thereof are described herein.

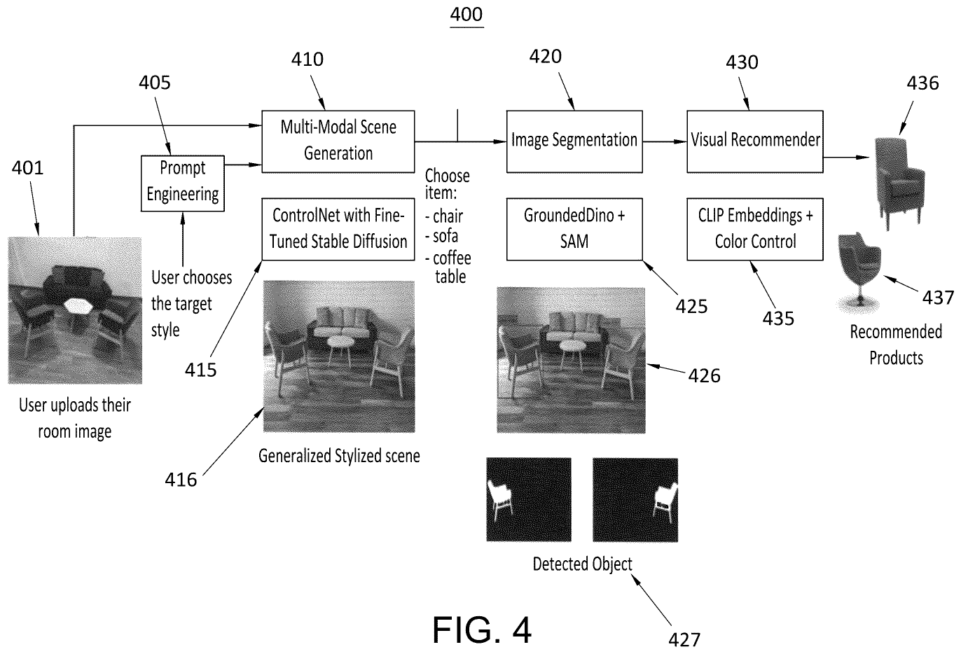

Turning ahead in the drawings, FIG. 4 illustrates a flow chart for a method 400. Method 400 can illustrate how to style a digital space using the multi-modal generative artificial intelligence, according to an embodiment. Method 400 further can illustrate how multi-modal generative artificial intelligence can learn via data from a feedback loop by tracking metrics during and after styling the digital space. Method 400 can be used in many different embodiments and/or examples not specifically depicted or described herein. In some embodiments, the procedures, the processes, and/or the activities of method 400 can be performed in the order presented or in parallel. In other embodiments, the procedures, the processes, and/or the activities of method 400 can be performed in any suitable order. In still other embodiments, one or more of the procedures, the processes, and/or the activities of method 400 can be combined or skipped. In several embodiments, system 300 (FIG. 3) can be suitable to perform method 400 and/or one or more of the activities of method 400.

In these or other embodiments, one or more of the activities of method 400 can be implemented as one or more computing instructions configured to run at one or more processors and configured to be stored at one or more non-transitory computer-readable media. Such non-transitory computer-readable media can be part of a computer system such as multi-modal styling system 310 and/or web server 320. The processor(s) can be similar or identical to the processor(s) described above with respect to computer system 100 (FIG. 1).

In several embodiments, method 400 can include an activity 401 of receiving a digital image uploaded by a computing device of a user. In some embodiments, method 400 can proceed after activity 401 to an activity 410. In several embodiments, method 400 can include an activity 405 of after receiving a user selection of a target style, prompting engineering to input the selection into activity 410.

In a number of embodiments, method 400 can include activity 410 of inputting digital images and target styles selected by the user into a multi-modal generative artificial intelligence (AI) scene generation model using ControlNet 415 with fined tuned stable diffusion to output image 416 of a generated digital image of a stylized room scene. As an example, target styles can include coastal, mid-century, bohemian, farmhouse, contemporary, glam, rustic, and/or another suitable style. In some embodiments, method 400 can proceed after activity 410 to an activity 420 of segmenting objects in the generated digital image. In a number of embodiments, activity 420 can include using a segmentation algorithm 425 that can detect objects in image 426 of the stylized room scene and create masks of the detected objects, such as image 427. In various embodiments, method 400 can proceed after activity 420 to an activity 430.

In several embodiments, method 400 additionally can include activity 430 of performing a visual search for complementary items with colors that are similar to the detected objects in the generated stylized scene. In some embodiments, activity 430 can comparing, using a deep learning model, colors and shapes of the detected object and multiple complementary items to virtually view the complementary item in the digital image space. In many embodiments, the deep learning model can include a contrastive language-image pre-training (CLIP) model 435 and/or another suitable deep learning model. As an example, image 436 and image 437 are generated digital images of complementary and/or recommended items based on the detected object in the stylized room scene.

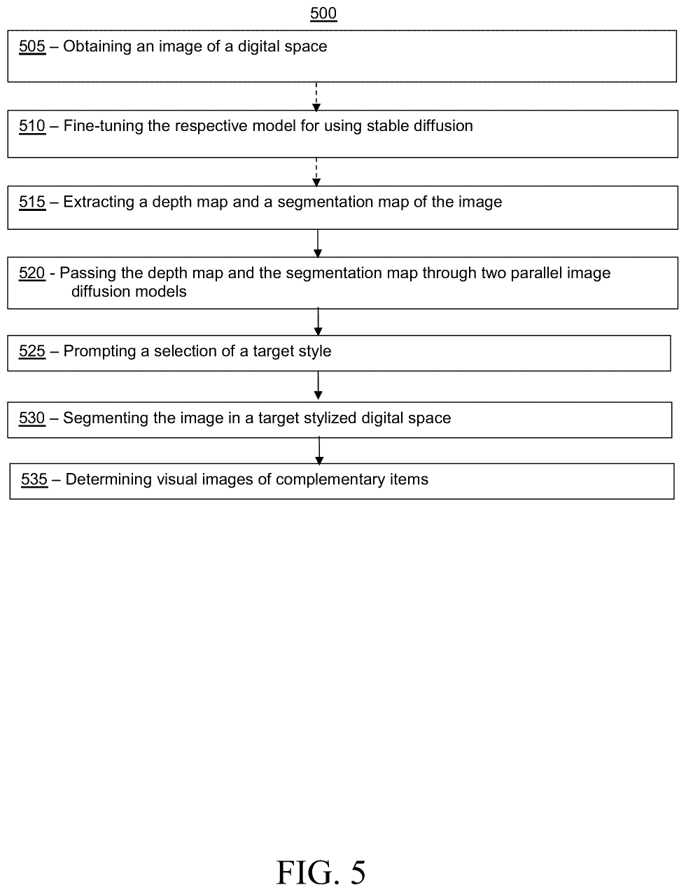

Turning ahead in the drawings, FIG. 5 illustrates a flow chart for a method 500, according to another embodiment. In some embodiments, method 500 can be a method of styling a digital space using multi-modal generative artificial intelligence. Method 500 is merely exemplary and is not limited to the embodiments presented herein. Method 500 can be utilized in many different embodiments and/or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped. In several embodiments, system 300 (FIG. 3) can be suitable to perform method 500 and/or one or more of the activities of method 500.

In these or other embodiments, one or more of the activities of method 500 can be implemented as one or more computing instructions configured to run at one or more processors and configured to be stored at one or more non-transitory computer-readable media. Such non-transitory computer-readable media can be part of a computer system such as multi-modal styling system 310 and/or web server 320. The processor(s) can be similar or identical to the processor(s) described above with respect to computer system 100 (FIG. 1).

Referring to FIG. 5, method 500 can include an activity 505 of obtaining an image of a digital space. In various embodiments, activity 505 also can include uploading the image captured by a computing device of a user.

In several embodiments, before passing each of the depth map and the segmentation map through the respective model of the two parallel image diffusion models (e.g., ControlNets), method 500 can alternatively and optionally include an activity 510 of fine-tuning the respective model for using stable diffusion.

In some embodiments, the respective model can be configured to generate an image from a text description of a target style from among multiple target styles.

In various embodiments, activity 510 also can include building a training dataset based on parameters comprising historical target styles and historical image captions corresponding to the historical target styles over a time period. In several embodiments, activity 510 further can include updating the parameters of the training dataset using a feedback loop of additional target styles and additional image captions.

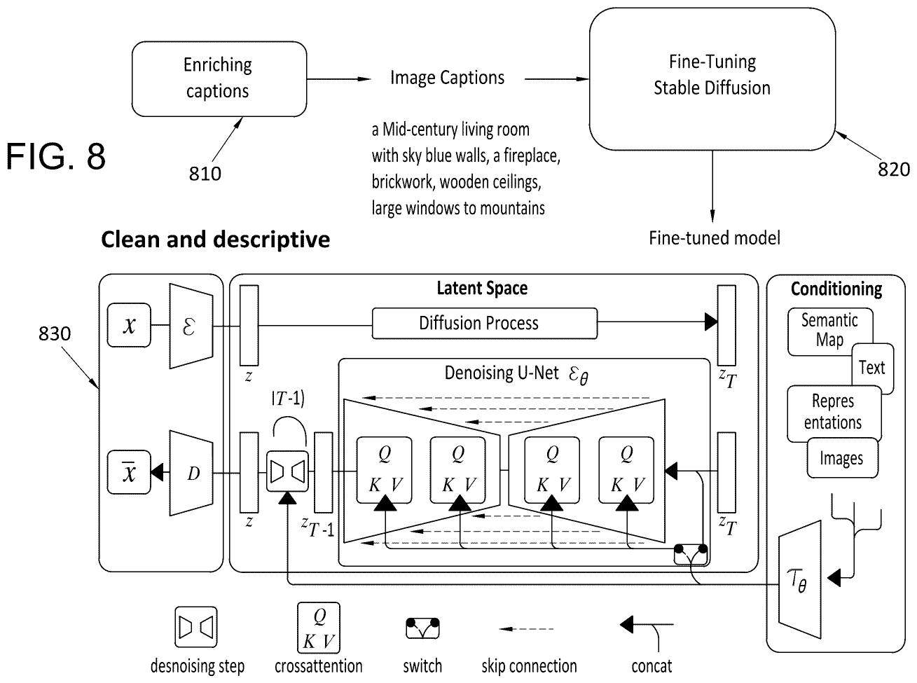

In some embodiments, activity 510 also can include enriching the historical image captions with clean descriptive text captions. FIG. 8 illustrates fine tuning stable diffusion by transforming image captions that are insufficiently descriptive of the text-to-image generative AI process to create digital spaces or scenes match the textual description. In some embodiments, FIG. 8 can include activity 810 of enriching image captions with clean and descriptive words to fine-tune the stable diffusion model. FIG. 8 further can include an activity 820 of tuning the stable diffusion model by conditioning the multiple main components of the stable diffusion model. In several embodiments, FIG. 8 also can include an algorithm 830 used to fine tune the stable diffusion model. As an example, conditioning an encoder and a decoder to a latent space, fine tuning a U-net model to denoise images, fine tuning a text encoder, and/or another suitable component of the stable diffusion model.

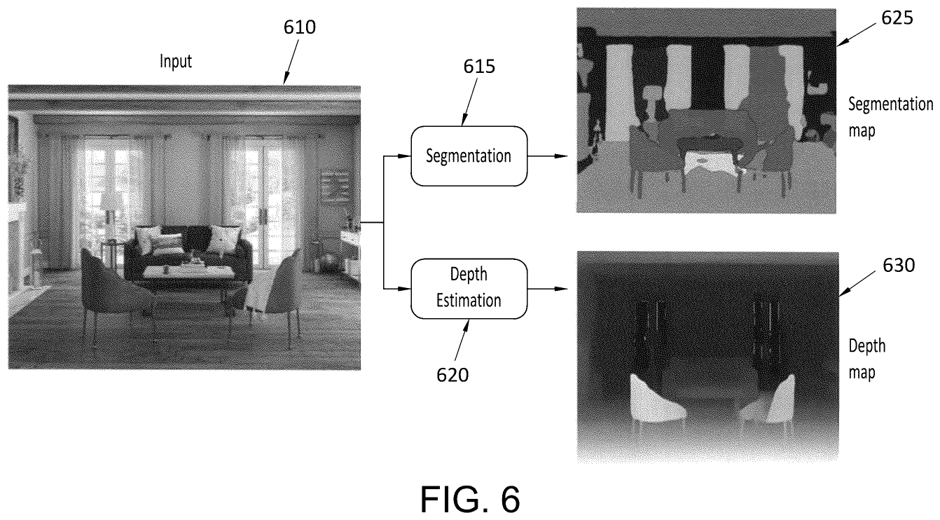

In a number of embodiments, method 500 further can include an activity 515 of extracting a depth map and a segmentation map of the image. In several embodiments, activity 515 also can include removing artifacts from the object. FIG. 6 illustrates examples of conditional mapping by extracting pixels from an image 610 to create a segmentation map 625 by using a segmentation algorithm 615. FIG. also illustrates conditional mapping extracting pixels from image 610 to create a depth map 630 by using a depth estimation algorithm 620.

Returning to FIG. 5, method 500 additionally can include an activity 520 of passing each of the depth map and the segmentation map through a respective model of two parallel image diffusion models using stable diffusion with controlled image generation (e.g., ConrolNet). In various embodiments, stable diffusion is a generative AI model and a controlled image generation is another generative AI model that when combined can generate a virtual layout of the digital image as cleaner and sharper virtual images styled in target themes, such as Coastal, Bohemian, etc. and to provide recommendations for objects present in the stylized generated virtual images. In some embodiments, the virtual images can be input in to a virtual space in the style of the targeted style. In several embodiments, the depth map can provide a distance of the object in the digital image away from the camera lens. In some embodiments, the segmentation map indicates where each object in the image is located in each region of the digital image.

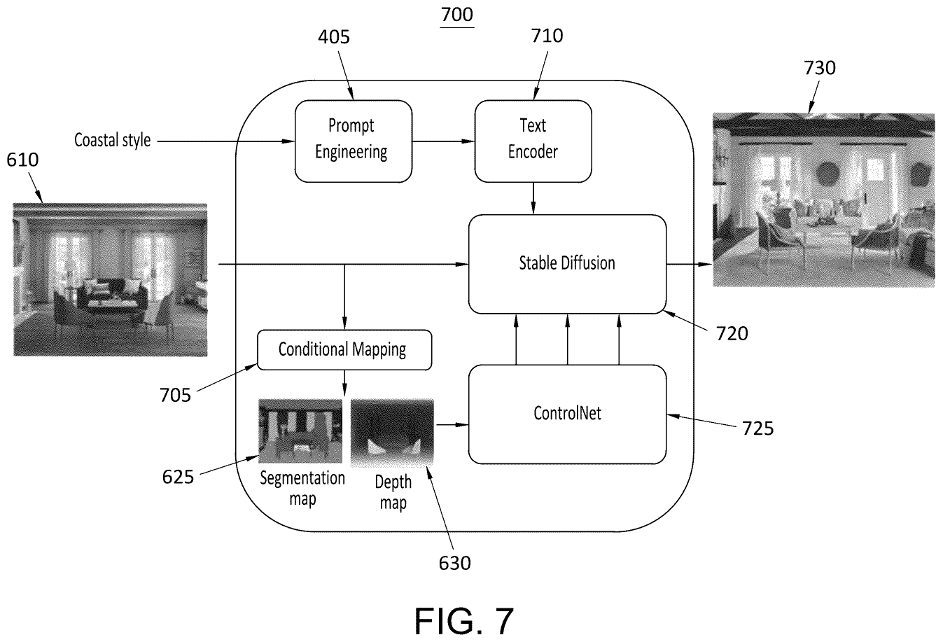

Jumping ahead in the drawings, FIG. 7 illustrates a block diagram for a method 700 of using a multi-modal scene generation model to style a digital space into a target style digital image, according to an embodiment. Method 700 can be used in many different embodiments and/or examples not specifically depicted or described herein. In some embodiments, the procedures, the processes, and/or the activities of method 700 can be performed in the order presented or in parallel. In other embodiments, the procedures, the processes, and/or the activities of method 700 can be performed in any suitable order. In still other embodiments, one or more of the procedures, the processes, and/or the activities of method 700 can be combined or skipped. In several embodiments, system 300 (FIG. 3) can be suitable to perform method 700 and/or one or more of the activities of method 700.

In these or other embodiments, one or more of the activities of method 700 can be implemented as one or more computing instructions configured to run at one or more processors and configured to be stored at one or more non-transitory computer-readable media. Such non-transitory computer-readable media can be part of a computer system such as multi-modal styling system 310 and/or web server 320. The processor(s) can be similar or identical to the processor(s) described above with respect to computer system 100 (FIG. 1).

In several embodiments, method 700 can include an image 610 (FIG. 6) of a selected target style, such as a coastal style, in which to use as a template to virtually style the uploaded image of the digital space in that style. In several embodiments, image 610 can be used as input to activity 405 (FIG. 4) and an activity 720.

In some embodiments, image 610 can be used to prompt activity 405 to transmit image 610 into a text encoder 710. In several embodiments, text encoder can encode a selected prompt such as “a coast living room” into a latent space understandable by stable diffusion. In many embodiments, text encoder 710 also can generate, using a generative deep learning model, a text-to-image digital image based on a learned text, such as “a coastal living room.” In some embodiments, the text can be input into an activity 720 to generate a digital image based on the target style.

In various embodiments, image 610 can be transformed, using conditional mapping 705, into a segmentation map 625 and a depth map 630. In several embodiments, segmentation map 625 and a depth map 630 can be input into activity 725 of generating, using controlled image generation, the digital target style image. In some embodiments, the digital style image combined with the stable diffusion text description can generate image 730 of the target style digital image.

In several embodiments, method 500 also can include an activity 525 of prompting a selection of a target style for the digital space.

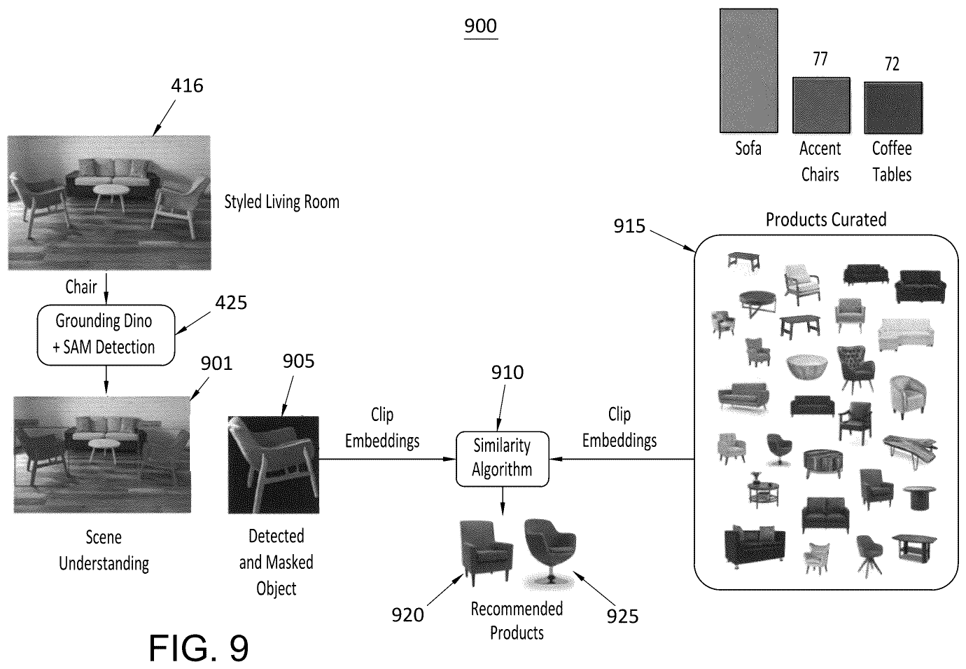

In a number of embodiments, method 500 also can include an activity 530 of segmenting, using image segmentation, the image in a target stylized digital space. Turning to ahead in the drawings, FIG. 9 illustrates a flow diagram for a method 900. Method 900 can illustrate how to segment image 416 of a generated digital image of a stylized room scene to identify objects of interest in the image 416. In some embodiments, method 900 can include an activity 425 of using a segmentation algorithm to identify the objects of the interest by created masks of the objects as shown in image 901. In various embodiments, method 900 can include an image 905 of the detected and masked object encoded using CLIP embeddings. In various embodiments, method 900 also can include CLIP embeddings of items 915 that are visual embeddings of complementary items to the object to interest. In some embodiments, method 900 can include an activity 910 of using a similarity algorithm to match the object of interest to a complementary item from items 915, such as complementary item 920 and complementary item 925.

Returning to FIG. 5, method 500 can include an activity 535 of determining, using dominant color filtering, visual images of complementary items.

In several embodiments, activity 535 of determining visual images also can include performing a visual search on an object in an uploaded image of the visual images. In some embodiments, activity 535 also can include detecting a mask of the object based on visual clip embeddings. In various embodiments, activity 535 additionally can include extracting visual clip embeddings of the complementary items in a database. In several embodiments, activity 535 also can include determining a complementary item of the complementary items matching the object based on an output of a similarity algorithm.

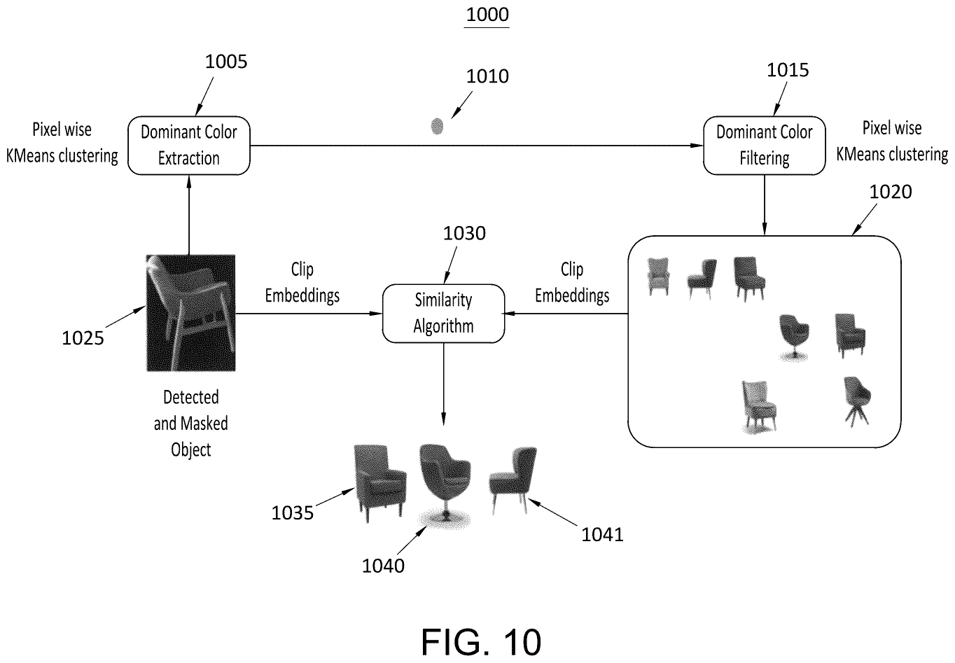

Turning ahead in the drawings, FIG. 10 illustrates a flow diagram for a method 1000. Method 1000 can illustrate dominant color filtering to create visual embeddings of a color profile matching a complementary dominant color of an item in the style of the target style, according to an embodiment. Method 1000 can include an activity 1005 of extracting a dominant color of an object of interest using pixel wise k-means clustering. In some embodiments, method 1000 can include a color 1010 of illustrating the dominant color as extracted. In various embodiments, method 1000 can include an activity 1015 of using dominant color filtering also using pixel wise k means clustering to identify similar colors in a list of complementary items 1020. In some embodiments, method 1000 can include an activity 1030 of using a similarity algorithm using CLIP embeddings for each of complementary items and CLIP embeddings for image 1025 of the detected and masked object to determine complementary items matching the dominant color, such as item 1035, item 1040, and item 1041.

Returning to FIG. 5, activity 535 of using dominant color filtering can include generating clusters of pixels of a dominant color in the object and the complementary items. In some embodiments, activity 535 also can include extracting the dominant color with hex codes of the object and the complementary items based on the clusters of pixels. In various embodiments, activity 535 further can include creating histograms of the dominant color of the object and the complementary items. In a number of embodiments, generating the clusters of pixels of the dominant color can include using k-means clustering.

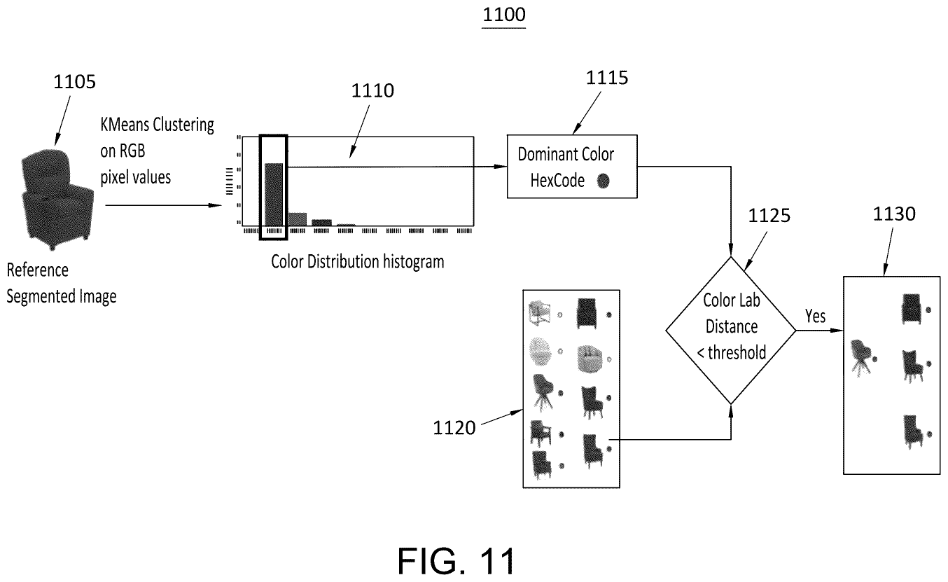

Turning ahead in the drawings, FIG. 11 illustrates a flow diagram for a method 1100. Method 1100 also can illustrate dominant color filtering using color histograms, according to an embodiment. Method 1100 can begin with a reference image 1105 to create color histograms, using k means clustering on RGB (e.g., red, green, blue color values) pixel values. In several embodiments, method 1100 also can include dominant hexcode 1115 as determined by the color histogram 1110. In some embodiments, method 1100 further can include complementary items 1120 where the complementary items have various RGB pixel values. In various embodiments, method 1100 can include an activity 1125 of determining whether or not to approve a complementary item based on the dominant color with a hex code. In some embodiments, if the output of activity 1125 is yes, method 1100 can proceed to output a list of complementary items 1130 with the dominant color with the hex code. If the output of activity 1125 is no, method 1100 ends.

Returning to FIG. 3, communication system 311 can at least partially perform activity 401 (FIG. 4) of receiving a digital image uploaded by a computing device of a user, activity 405 (FIG. 4) of after receiving a user selection of a target style, prompting engineering to input the selection into activity 410 (FIG. 4), activity 505 (FIG. 5) of obtaining an image of a digital space, activity 505 (FIG. 5) also can include uploading the image captured by a computing device of a user, and/or activity 525 (FIG. 5) of prompting a selection of a target style for the digital space. In many embodiments, segmentation system 312 can at least partially perform activity 420 (FIG. 4) of segmenting objects in the generated digital image, and/or activity 530 (FIG. 5) of segmenting, using image segmentation, the image in a target stylized digital space,

In some embodiments, machine learning system 313 can at least partially perform activity 410 (FIG. 4) of inputting digital images and target styles selected by the user into a multi-modal generative artificial intelligence (AI) scene generation model using control net 415 (FIG. 4) with fined tuned stable diffusion to output image 416 (FIG. 4) of a generated digital image of a stylized room scene, and/or activity 520 (FIG. 5) of passing each of the depth map and the segmentation map through a respective model of two parallel image diffusion models using stable diffusion with controlled image generation.

In several embodiments, extracting system 314 can at least partially perform activity 515 (FIG. 5) of extracting a depth map and a segmentation map of the image.

In a number of embodiments, tuning system 315 can at least partially perform activity 510 (FIG. 5) of fine-tuning the respective model for using stable diffusion, activity 810 (FIG. 8) of enriching image captions with clean and descriptive words to fine-tune the stable diffusion model, and/or activity 820 (FIG. 8) of tuning the stable diffusion model by conditioning the multiple main components of the stable diffusion model.

In various embodiments, visual searching system 316 can at least partially perform activity 430 (FIG. 4) of performing a visual search for complementary items with colors that are similar to the detected objects in the generated stylized scene, activity 535 (FIG. 5) of determining, using dominant color filtering, visual images of complementary items, activity 535 (FIG. 5) of determining, using dominant color filtering, visual images of complementary items, activity 1005 (FIG. 10) of extracting a dominant color of an object of interest using pixel wise k-means clustering, activity 1015 (FIG. 10) of using dominant color filtering also using pixel wise k means clustering to identify similar colors in a list of complementary items 1020 (FIG. 10), activity 1030 (FIG. 10) of using a similarity algorithm using CLIP embeddings for each of complementary items and CLIP embeddings for image 1025 (FIG. 10) of the detected and masked object to determine complementary items matching the dominant color, such as item 1035 (FIG. 10), item 1040 (FIG. 10), and item 1041 (FIG. 10), activity 535 (FIG. 5) of using dominant color filtering can include generating clusters of pixels of a dominant color in the object and the complementary items, and/or activity 1125 (FIG. 11) of determining whether or not to approve a complementary item based on the dominant color with a hex code.

In several embodiments, web server 320 can include a webpage system 321. Webpage system 321 can at least partially perform sending instructions to user computers (e.g., 350-351 (FIG. 3)) based on information received from communication system 311.

In many embodiments, the techniques described herein can be used continuously at a scale that cannot be handled using manual techniques.

In a number of embodiments, the techniques described herein can solve a technical problem that arises only within the realm of computer networks, as creating digital spaces to visual a target style room and to add complementary items in virtual spaces inside the digital room space does not exist outside the realm of computer networks. Moreover, the techniques described herein can solve a technical problem that cannot be solved outside the context of computer networks. Specifically, the techniques described herein cannot be used outside the context of computer networks and in view of a virtual technology, that is part of the techniques described herein would not exist.

Various embodiments can include a system including a processor and a non-transitory computer-readable media storing computing instructions that, when executed on the processor, cause the processor to perform certain operations. The operations can include obtaining an image of a digital space. The operations also can include extracting a depth map and a segmentation map of the image. The operations further can include passing each of the depth map and the segmentation map through a respective model of two parallel image diffusion models using stable diffusion with controlled image generation. The operations additionally can include prompting a selection of a target style for the digital space. The operations also can include segmenting, using image segmentation, the image in a target stylized digital space. The operations further can include determining, using dominant color filtering, visual images of complementary items.

A number of embodiments can include a computer-implemented method. The method can include obtaining an image of a digital space. The method also can include extracting a depth map and a segmentation map of the image. The method further can include passing each of the depth map and the segmentation map through a respective model of two parallel image diffusion models using stable diffusion with controlled image generation. The method additionally can include prompting a selection of a target style for the digital space. The method also can include segmenting, using image segmentation, the image in a target stylized digital space. The method further can include determining, using dominant color filtering, visual images of complementary items.

Additional embodiments can include a non-transitory computer-readable media storing computing instructions that, when executed on a processor, cause the processor to perform certain operations. The operations can include obtaining an image of a digital space. The operations also can include extracting a depth map and a segmentation map of the image. The operations further can include passing each of the depth map and the segmentation map through a respective model of two parallel image diffusion models using stable diffusion with controlled image generation. The operations additionally can include prompting a selection of a target style for the digital space. The operations also can include segmenting, using image segmentation, the image in a target stylized digital space. The operations further can include determining, using dominant color filtering, visual images of complementary items.

Although styling a space using multi-modal generative artificial intelligence has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-11 may be modified, and that the foregoing discussion of certain of these embodiments does not necessarily represent a complete description of all possible embodiments. For example, one or more of the procedures, processes, or activities of FIGS. 4-5 and 7-11 may include different procedures, processes, and/or activities and be performed by many different modules, in many different orders, and/or one or more of the procedures, processes, or activities of FIGS. 4-5 and 7-11 may include one or more of the procedures, processes, or activities of another different one of FIGS. 4-5 and 17-11. Additional details regarding communication system 311, segmentation system 312, machine learning system 313, extracting system 314, tuning system 315, visual search system 316, database system 317, web server 320, and/or webpage system 321, (FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising a processor and a non-transitory computer-readable medium storing computing instructions that, when executed on the processor, cause the processor to perform operations comprising:
obtaining an image of a digital space;
extracting a depth map and a segmentation map of the image;
passing each of the depth map and the segmentation map through a respective model of two parallel ControlNet models using stable diffusion for controlled image generation;
prompting a selection of a target style for the digital space;
segmenting, using image segmentation, the image in a target stylized digital space; and
determining, using dominant color filtering, visual images of complementary items.

2. The system of claim 1, wherein obtaining the image of the digital space comprises:
uploading the image captured by a computing device of a user.

3. The system of claim 1, wherein the depth map and the segmentation map of the image are used in the two parallel ControlNet models for the controlled image generation with reduced artifacts.

4. The system of claim 1, wherein the operations further comprise, before passing each of the depth map and the segmentation map through the respective model of the two parallel ControlNet models using the stable diffusion:
fine-tuning the stable diffusion of the respective model for the controlled image generation.

5. The system of claim 4, wherein the respective model is configured to generate an image from a text description of a target style from among multiple target styles.

6. The system of claim 5, wherein fine-tuning the respective model comprises:
building a training dataset based on parameters comprising historical target styles and historical image captions corresponding to the historical target styles over a time period; and
updating the parameters of the training dataset using a feedback loop of additional target styles and additional image captions.

7. The system of claim 6, wherein fine-tuning the respective model further comprises:
enriching the historical image captions with clean descriptive text captions.

8. The system of claim 1, determining the visual images comprises:
performing a visual search on an object in an uploaded image of the visual images;
detecting and masking objects using segmentation models;
obtaining CLIP embeddings of the objects, as masked;
comparing the CLIP embeddings with pre-computed visual clip embeddings of the complementary items in a database; and
determining a recommended item of the complementary items matching the object based on an output of a similarity algorithm.

9. The system of claim 8, wherein using dominant color filtering comprises:
generating clusters of pixels of a dominant color in the object and the complementary items;
extracting the dominant color with hex codes of the object and the complementary items based on the clusters of pixels; and
creating histograms of the dominant color of the object and the complementary items.

10. The system of claim 9, wherein generating the clusters of pixels of the dominant color comprises using k-means clustering.

11. A computer-implemented method comprising:
obtaining an image of a digital space;
extracting a depth map and a segmentation map of the image;
passing each of the depth map and the segmentation map through a respective model of two parallel ControlNet models using stable diffusion for controlled image generation;
prompting a selection of a target style for the digital space;
segmenting, using image segmentation, the image in a target stylized digital space; and
determining, using dominant color filtering, visual images of complementary items.

12. The computer-implemented method of claim 11, wherein obtaining the image of the digital space comprises:
uploading the image captured by a computing device of a user.

13. The computer-implemented method of claim 11, wherein the depth map and the segmentation map of the image are used in the two parallel ControlNet models for the controlled image generation with reduced artifacts.

14. The computer-implemented method of claim 11 further comprising:
before passing each of the depth map and the segmentation map through the respective model of the two parallel ControlNet models using the stable diffusion:
fine-tuning the stable diffusion of the respective model for the controlled image generation.

15. The computer-implemented method of claim 14, wherein the respective model is configured to generate an image from a text description of a target style from among multiple target styles.

16. The computer-implemented method of claim 15, wherein fine-tuning the respective model comprises:
building a training dataset based on parameters comprising historical target styles and historical image captions corresponding to the historical target styles over a time period; and
updating the parameters of the training dataset using a feedback loop of additional target styles and additional image captions.

17. The computer-implemented method of claim 16, wherein fine-tuning the respective model further comprises:
enriching the historical image captions with clean descriptive text captions.

18. The computer-implemented method of claim 11, determining the visual images comprises:
performing a visual search on an object in an uploaded image of the visual images;
detecting and masking objects using segmentation models;
obtaining CLIP embeddings of the objects, as masked;
comparing the CLIP embeddings with pre-computed visual clip embeddings of the complementary items in a database; and
determining a recommended item of the complementary items matching the object based on an output of a similarity algorithm.

19. A non-transitory computer-readable medium storing computing instructions that, when executed on a processor, cause the processor to perform operations comprising:
obtaining an image of a digital space;
extracting a depth map and a segmentation map of the image;
passing each of the depth map and the segmentation map through a respective model of two parallel ControlNet models using stable diffusion for controlled image generation;
prompting a selection of a target style for the digital space;
segmenting, using image segmentation, the image in a target stylized digital space; and
determining, using dominant color filtering, visual images of complementary items.

20. The non-transitory computer-readable medium of claim 19, wherein obtaining the image of the digital space comprises:
uploading the image captured by a computing device of a user.
